(19) United States
(12) Patent Application Publication
(10) Pub. No.: US 2025/0374101 A1
(43) Pub. Date: Dec. 4, 2025

(54) QUALITY OF EXPERIENCE MEASUREMENT REPORTING

(71) Applicant: Nokia Technologies Oy, Espoo (FI)

(72) Inventors: Jing HE, Beijing (CN); Ping YUAN, Beijing (CN); Malgorzata TOMALA, Wrickaw (PL); Guillaume DECARREAU, Munich (DE); Hakon HELMERS, Massy (FR)

(21) Appl. No.: 19/105,405

(22) PCT Filed: Sep. 30, 2022
(86) PCT No.: PCT/CN2022/123461

§ 371 Date: Feb. 21, 2025

(51) Int. Cl. H04W 24/10; H04L 41/5067

(52) U.S. Cl. CPC H04W 24/10; H04L 41/5067

(57) ABSTRACT

Embodiments of the present disclosure relate to QoE measurement reporting. A terminal device receives, from a first network device, a message indicative of pausing QoE reporting to the first network device. Then the terminal device transmits, to the first network device, a message for requesting a SRB configuration with a second network device. Next, the terminal device transmits, to the second network device. QoE measurement result based on the received SRB configuration. Thus, timely and effective QoE measurement reporting mechanism is provided.

### FIELD

Various example embodiments relate to the field of telecommunication and in particular, to a method, device, apparatus and computer readable storage medium for quality of experience measurement reporting.

### BACKGROUND

In the communications area, there is a constant evolution ongoing in order to provide efficient and reliable solutions for utilizing wireless communication networks. Each new generation has it owns technical challenges for handling the different situations and processes that are needed to connect and serve devices connected to the wireless network. To meet the demand for wireless data traffic having increased since deployment of 4th generation (4G) communication systems, efforts have been made to develop an improved 5th generation (5G) or pre-5G communication system. The new communication systems can support various types of service applications for terminal devices.

In the wireless environment, user's experience at terminal devices will be influenced by various factors, such as suitableness, flexibility, mobility, security, cost, stability and so on. In order to evaluate the user's experience, Quality of experience (QoE) is provided to measure the delight or annoyance of a user's experience with a service (e.g., web browsing, phone call, TV broadcast). Efficient solutions are still desirable for improving user's experience.

### SUMMARY

In general, example embodiments of the present disclosure provide a solution for quality of experience measurement reporting.

In a first aspect, there is provided a terminal device in a radio access network. The terminal device comprises at least one processor; and at least one memory including computer program codes; the at least one memory and the computer program codes are configured to, with the at least one processor, cause the terminal device to after receiving a pause indication for QoE measurement reporting, transmit an AS measurement report to a first network device in the radio access network, based on an AS measurement configuration enabling QoE measurement reporting continuity or transmit a request for the AS measurement configuration; receive a SRB configuration for establishing a SRB for QoE measurement reporting between the terminal device and a second network device in the radio access network; and transmit a QoE measurement report to the second network device via the established SRB.

In a second aspect, there is provided a first network device in a radio access network. The first network device comprises at least one processor; and at least one memory including computer program codes; the at least one memory and the computer program codes are configured to, with the at least one processor, cause the first network device to receive an AS measurement report associated with a terminal device in the radio access network or receive a request for an AS measurement configuration enabling QoE measurement reporting continuity for the terminal device, the AS measurement report being generated based on the AS measurement configuration enabling the QoE measurement reporting continuity; obtain a SRB configuration for establishing a SRB for QoE measurement reporting for the terminal device; and transmit the SRB configuration for establishing the SRB to the terminal device.

In a third aspect, there is provided a second network device in a radio access network. The second network device comprises at least one processor; and at least one memory including computer program codes; the at least one memory and the computer program codes are configured to, with the at least one processor, cause the second network device to receive, from a first network device in the radio access network, a request for establishing a SRB for QoE measurement reporting between a terminal device in the radio access network and the second network device; transmit a SRB configuration for establishing the SRB to the first network device or the terminal device; and receive a QoE measurement report from the terminal device via the established SRB.

In a fourth aspect, there is provided a method implemented at a terminal device. The method comprises: after receiving a pause indication for QoE measurement reporting, transmitting, at a terminal device in a radio access network, an AS measurement report to a first network device in the radio access network, based on an AS measurement configuration enabling QoE measurement reporting continuity or transmitting a request for the AS measurement configuration; receiving a SRB configuration for establishing a SRB for QoE measurement reporting between the terminal device and a second network device in the radio access network; and transmitting a QoE measurement report to the second network device via the established SRB.

In a fifth aspect, there is provided a method implemented at a network device. The method comprises: receiving, at a first network device in a radio access network, an AS measurement report associated with a terminal device in the radio access network or receiving a request for an AS measurement configuration enabling QoE measurement reporting continuity for the terminal device, the AS measurement report being generated based on the AS measurement configuration enabling the QoE measurement reporting continuity; obtaining a SRB configuration for establishing a SRB for QoE measurement reporting for the terminal device; and transmitting the SRB configuration for establishing the SRB to the terminal device.

In a sixth aspect, there is provided a method implemented at a further network device. The method comprises: receiving, at a second network device in a radio access network from a first network device in the radio access network, a request for establishing a SRB for QoE measurement reporting between a terminal device in the radio access network and the second network device; transmitting a SRB configuration for establishing the SRB to the first network device or the terminal device; and receiving a QoE measurement report from the terminal device via the established SRB.

In a seventh aspect, there is provided an apparatus comprising: means for after receiving a pause indication for QoE measurement reporting, transmitting, at a terminal device in a radio access network, an AS measurement report to a first network device in the radio access network, based on an AS measurement configuration enabling QoE measurement reporting continuity or transmitting a request for the AS measurement configuration; means for receiving a SRB configuration for establishing a SRB for QoE measurement reporting between the terminal device and a second network device in the radio access network; and means for transmitting a QoE measurement report to the second network device via the established SRB.

In an eighth aspect, there is provided an apparatus comprising: means for receiving, at a first network device in a radio access network, an AS measurement report associated with a terminal device in the radio access network or receiving a request for an AS measurement configuration enabling QoE measurement reporting continuity for the terminal device, the AS measurement report being generated based on the AS measurement configuration enabling the QoE measurement reporting continuity; means for obtaining a SRB configuration for establishing a SRB for QoE measurement reporting for the terminal device; and means for transmitting the SRB configuration for establishing the SRB to the terminal device.

In a ninth aspect, there is provided an apparatus comprising: means for receiving, at a second network device in a radio access network, from a first network device in the radio access network, a request for establishing a SRB for QoE measurement reporting between a terminal device in the radio access network and the second network device; means for transmitting a SRB configuration for establishing the SRB to the first network device or the terminal device; and means for receiving a QoE measurement report from the terminal device via the established SRB.

In a tenth aspect, there is provided a non-transitory computer readable medium comprising program instructions for causing an apparatus to perform at least the method according to any one of the above fourth to sixth aspect.

In a eleventh aspect, there is provided a terminal device in a radio access network comprising: first transmitting circuitry configured to after receiving a pause indication for QoE measurement reporting, transmit an AS measurement report to a first network device in the radio access network, based on an AS measurement configuration enabling QoE measurement reporting continuity or transmit a request for the AS measurement configuration; receiving circuitry configured to receive a SRB configuration for establishing a SRB for QoE measurement reporting between the terminal device and a second network device in the radio access network; and second transmitting circuitry configured to transmit a QoE measurement report to the second network device via the established SRB.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which embodiments of the present disclosure may be implemented;

FIG. 2 illustrates a flowchart illustrating a process for QoE measurement reporting continuity according to some embodiments of the present disclosure;

FIG. 3 illustrates a flowchart illustrating a process for QoE measurement reporting continuity according to some embodiments of the present disclosure;

FIG. 4 illustrates a flowchart illustrating a process for QoE measurement reporting continuity according to some embodiments of the present disclosure;

FIG. 5 illustrates a flowchart illustrating a process for QoE measurement reporting continuity according to some embodiments of the present disclosure;

FIG. 6 illustrates a flowchart of a method implemented at a terminal device according to some embodiments of the present disclosure;

FIG. 7 illustrates a flowchart of a method implemented at a network device according to some embodiments of the present disclosure;

FIG. 8 illustrates a flowchart of a method implemented at a network device according to some other embodiments of the present disclosure;

FIG. 9 illustrates a simplified block diagram of an apparatus that is suitable for implementing embodiments of the present disclosure; and

FIG. 10 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

QoE are typically defined for certain application/service as the parameters used to describe the Quality of Service (QOS). QoE measurement reporting is essential for ensuring good network service. However, in practice, QoE measurement reporting may need to be handled under RAN overload.

In view of the RAN overload situation, the Pause/Resume mechanism has been standardized for NR Standalone scenario in Rel-17. In order to mitigate RAN overload during an ongoing QoE session, QoE reporting should be able to be temporarily stopped and restarted under the control of gNB. The mechanism in Rel-17 enables QoE measurement collection control in Standalone deployment (with MN only). In this way, UE has to buffer QoE reporting data to wait system overload status to be recovered, and UE doesn't know how long UE can receive resume command. The NR enhanced QoE WI in Rel-18 targets to extend QoE measurement functionality to NR-Dual Connectivity (DC) scenario. In one valid use case of NR-DC scenario, one leg (MN leg) is paused by network node, another leg (SN leg, resulting from DC may be used to send QoE measurement reporting data, so as to maintain reporting continuity.

Although the NR-DC architecture alleviates the reporting problem under some RAN overload situation, a timely and effective QoE measurement reporting mechanism is still desirable for reporting continuity under other RAN overload situation in which the reporting cannot be achieved, for example, in which both legs (MN leg and SN leg) in NR-DC scenario cannot be used to send QoE measurement reporting data.

According to embodiments of the present disclosure, there is providing a solution for improved QoE measurement reporting. A terminal device receives, from a first network device, a message indicative of pausing QoE reporting to the first network device. Then the terminal device transmits, to the first network device, a message for requesting a SRB configuration with a second network device. Next, the terminal device transmits, to the second network device, QoE measurement result based on the received SRB configuration. As such, a timely and effective QoE measurement reporting mechanism is provided.

Principle and embodiments of the present disclosure will be described in detail below with reference to the accompanying drawings. However, it is to be noted that these embodiments are illustrated as examples and not intended to limit scope of the present application in any way.

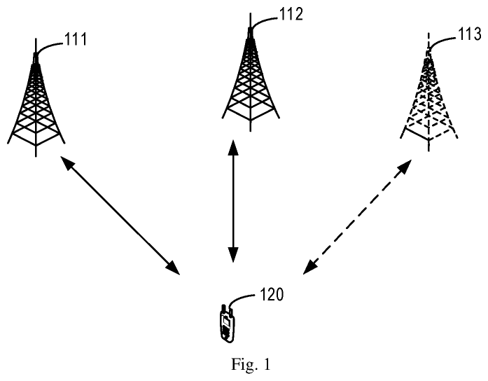

Reference is first made to FIG. 1, which illustrates an example communication system 100 in which embodiments of the present disclosure may be implemented. As illustrated in FIG. 1, the system 100 includes two network devices, such as network device 111 (can be considered as a first network device herein) and network device 112 (can be considered as a second network device or a further network device herein). It is to be understood that the network device 111 and network device 112 can be used interchangeably. In other words, the network device 111 can be considered a second network device or a further network device, and network device 112 can be considered a first network device. The network devices 111 and 112 may each have one respective group of antenna ports. The network devices 111 and 112 may each operate using different frequency bands in both DL and UL. In communication systems, “UL” refers to a communication link in a direction from a terminal device to a network device, and “DL” refers to a communication link in a direction from the network device to the terminal device.

The system 100 also includes one or more terminal devices, such as terminal device 120. The terminal device 120 are capable of connecting, for example wirelessly, and communicating in an UL and DL with either or both of the network devices 111 and 112 depending on location of the terminal devices in the cells of the network devices 111 and 112. The terminal device 120 may be configured to be communicated with network via one or more TRPs, for example 2 TRPs. The two TRPs may be located within the same cell (intra-cell TRP) or within different cells (inter-cell TRP).

It is to be understood that in FIG. 1, the number of network devices and terminal devices is only for the purpose of illustration without suggesting any limitations. The system 100 may include any suitable number of network devices and terminal devices adapted for implementing embodiments of the present disclosure. For example, The system 100 may include network device 113 (can be considered as third network device herein)

Communications in the communication system 100 may be implemented according to any proper communication protocol(s), comprising, but not limited to, cellular communication protocols of the third generation (3G), the fourth generation (4G) and the fifth generation (5G) or beyond, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD). Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

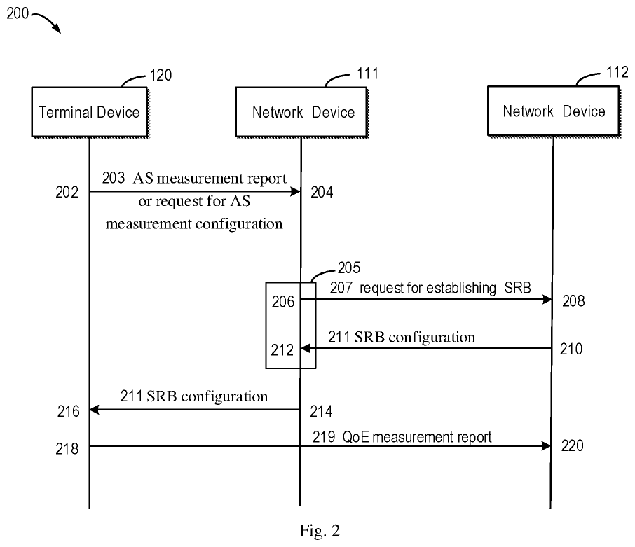

Reference is now made to FIG. 2, which shows a process 200 for QoE measurement reporting continuity according to various embodiments of the present disclosure. For the purpose of discussion, the process 200 will be described with reference to FIG. 1. The process 200 may involve the terminal device 120 and the network devices 111, 112 as illustrated in FIG. 1. It is to be appreciated that any graphic elements, numerical values, and descriptive text in these figures are only for the purpose of illustration without suggesting any limitations.

In the process 200, after receiving a pause indication for QoE measurement reporting, the terminal device 120 transmits (202) an AS measurement report 203 to the network device 111 in the radio access network, based on an AS measurement configuration enabling QoE measurement reporting continuity or transmits (202) a request 203 for the AS measurement configuration.

In some embodiments, the request for the AS measurement configuration may be transmitted via an uplink Radio Resource control (RRC) message. At the network side, the network device 111 may transmit, to the terminal device 120, the AS measurement configuration enabling the QoE measurement reporting continuity. Accordingly, the terminal device 120 may receive, from the network device 111, the AS measurement configuration enabling the QoE measurement reporting continuity. In an example, the AS measurement configuration is received via an RRC reconfiguration message. The AS measurement configuration comprises an indication that the AS measurement configuration is configured for supporting the QoE measurement reporting continuity.

As an example, the terminal device 120 may receive the AS measurement configuration from the network device 112. As another example, the terminal device 120 may receive the AS measurement configuration from the network device 111 and the network device 112.

In some embodiments, the AS measurement configuration enabling the QoE measurement reporting continuity may comprise: a measurement event with a threshold configured for triggering the AS measurement report within a time period for measurement event running determined based on a requirement of the QoE measurement reporting continuity; a periodic measurement within a time period for periodic measurement running determined based on the requirement of the QoE measurement reporting continuity; or a timer for causing the terminal device 120 to report an available measurement result based on expiry of the timer, even if no measurement result reaches the configured threshold; or any combination thereof.

In some embodiments, at the network side, the network device 111 may transmit, to the terminal device 120, a pause indication for the QoE measurement reporting. Accordingly, based on receiving the pause indication for the QoE measurement reporting, the terminal device 120 performs a measurement based on the AS measurement configuration to generate the AS measurement report. Alternatively, the pause indication may be received from the network device 112.

In some embodiments, the terminal device 120 is in a dual connectivity mode, the network device 111 is a master node (MN), and the network device 112 is a secondary node (SN). The pause indication may be received from both the network device 111 and the network device 112. Alternatively, the network device 111 is a SN, and the network device 112 is a MN.

In some embodiments, in the scenario where the terminal device 120 is in a dual connectivity mode in which terminal device 120 is having connection with the network device 111 and the network device 112, in case one network device has paused the QoE measurement reporting for the terminal device 120, it needs to inform another network device to avoid pause in another leg, for QoE reporting continuity. The network device 111 may transmit, to the network device 112, an indication that the QoE measurement reporting through the network device 111 is paused. Alternatively, the network device 112 may transmit, to the network device 111, an indication that the QoE measurement reporting through the network device 112 is paused.

In some embodiments, the terminal device 120 may transmit the AS measurement report or the request by: based on receiving the pause indication for the QoE measurement reporting, determining whether the terminal device 120 is configured with the AS measurement configuration enabling the QoE measurement reporting continuity; based on determining that the terminal device 120 is configured with the AS measurement configuration, transmitting the AS measurement report; and based on determining that the terminal device 120 is not configured with the measurement configuration, transmitting the request for the AS measurement configuration.

Alternatively, the terminal device 120 may transmit the AS measurement report or the request based on: determining that an amount of buffered data for the QoE measurement reporting is equal to or greater than a threshold. At the network side, the network device 111 may configure a threshold for causing the terminal device 120 to transmit the AS measurement report based on determining that an amount of buffered data of the QoE measurement reporting at the terminal device 120 is equal to or greater than the threshold.

Continuing with reference to FIG. 2, at the network side, the network device 111 receives (204) the AS measurement report associated with the terminal device 120 or receives (204) the request for the AS measurement configuration enabling QoE measurement reporting continuity for the terminal device 120.

In some embodiments, in the scenario where the terminal device 120 is in a dual connectivity mode in which the network device 111 is a MN and the network device 112 is a SN of the terminal device 120, the network device 111 may transmit, to the network device 112, information about overloading status of the network device 111 to request the network device 112 to coordinate the QoE measurement reporting continuity. Alternatively, the network device 112 may transmit, to the network device 111, information about overloading status of the network device 112 to request the network device 111 to pause the QoE measurement reporting through the network device 112.

In some embodiments, the network device 111 may select, based on the received AS measurement report, the network device 112 from a plurality of candidate network devices as a target network device. As an example, the network device 111 may select the target network device based on: determining that the terminal device 120 is in a standalone mode. The network device 111 may initiate a dual connectivity setup procedure with the network device 112, accordingly, the network device 112 may be a MN and the network device 112 may be a SN. As another example, in the scenario where the terminal device 120 is in a dual connectivity mode in which terminal device 120 is having connection with the network device 111 and the network device 112, the network device 111 may select a target secondary PSCell of the network device 112 and initiate a secondary PSCell change procedure towards the network device 112.

Continuing with reference to FIG. 2, based on receiving the AS measurement report or the request from the terminal device 120, the network device 111 transmits (206), to the network device 112, a request 207 for establishing the SRB between the terminal device 120 and the network device 112. In an example, the network device 111 may transmit the request for establishing the SRB by: transmitting, to the network device 112, an SN addition message or an SN modification message comprising an indication for requesting the network device 112 to establish the SRB. Accordingly, the network device 112 may receive the request for establishing the SRB by: receiving, from the network device 111, the SN addition message or an SN modification message.

As an example, when the UE is in the standalone mode, the network device 111 may initiate a dual connectivity setup procedure with the network device 112 by transmitting to the network 112 an SN addition message to establish the SRB. As another example, in the scenario where the terminal device 120 is in a dual connectivity mode in which terminal device 120 is having connection with the network device 111 and the network device 112, the network device 111 may initiate a secondary PSCell change procedure towards the network device 112 by transmitting an SN modification message to establish the SRB.

Accordingly, the network device 112 receives (208), from the network device 111, the request for establishing the SRB for QoE measurement reporting between terminal device 120 and the network device 112. The network device 112 transmits (210) a SRB configuration 211 for establishing the SRB to the network device 111 or the terminal device 120. As an example, the SRB comprises at least one of an existing SRB3, a split SRB4, or a new SRB5.

Accordingly, the network device 111 receives (212), from the network device 112, the SRB configuration for establishing the SRB. With the transmission (206) and reception (212), the network device 111 obtains (205) the SRB configuration for establishing the SRB for QoE measurement reporting for terminal device 120. Then, the network device 111 transmits (214) the SRB configuration 211 for establishing the SRB to the terminal device 120.

Alternatively, the SRB for the QoE measurement reporting is between the terminal device 120 and the network device 111. The network device 111 may obtain the SRB configuration by: based on receiving the AS measurement report or the request for establishing the SRB from the network device 112, determining the SRB configuration for establishing the SRB between the network device 111 and the terminal device 120.

Continuing with reference to FIG. 2, the terminal device 120 receives (216) the SRB configuration for establishing the SRB for QoE measurement reporting between the terminal device 120 and the network device 112. In an example, the SRB configuration is received via an RRC reconfiguration message. The terminal device may receive the SRB configuration from the network device 111 or the network device 112.

Then, the terminal device 120 transmits (218) a QoE measurement report to the network device 112 via the established SRB. At the network side, the network device 112 receives (220) the QoE measurement report from the terminal device 120 via the established SRB.

Alternatively, the terminal device 120 may receive the SRB configuration for establishing the SRB for QoE measurement reporting between the terminal device 120 and the network device 111. Then, the terminal device 120 may transmits a QoE measurement report to the network device 111 via the established SRB. At the network side, the network device 111 may receive the QoE measurement report from the terminal device 120 via the established SRB.

With the above process, a timely and effective QoE measurement reporting mechanism is provided for reporting continuity under various RAN overload situation. Enhanced QoE measurement reporting continuity can further improve user's experience.

In some embodiments, in the scenario where the terminal device 120 is in a dual connectivity mode in which the network device 111 is a MN and the network device 113 (as shown in FIG. 1) in the radio access network is a SN of the terminal device 120, the terminal device 120 may receive the pause indication by receiving one of a pause indication from the network device 111 and another pause indication from a network device 113 after the other one is received previously. Alternatively, the terminal device 120 may receive the pause indication by receiving, from one of the network device 111 and the network device 113, a pause indication that the QoE measurement reporting through both the network device 111 and the network device 113 is paused.

In some embodiments, based on determining that the pause indication from the network device 111 is received after the pause indication from the network device 113 is received, the terminal device 120 may further transmit, to the network device 111, the request for the AS measurement configuration.

In some embodiments, based on determining that the pause indication from the network device 113 is received after the pause indication is received from the network device 111, the terminal device 120 may further transmit, to the network device 113, the request for the AS measurement configuration.

In some embodiments, based on receiving the pause indication that the QoE measurement reporting through both the network device 111 and the network device 113 is paused, the terminal device 120 may further transmit, to one of the network device 111 and the network device 113, the request for the AS measurement configuration.

In some embodiments, At the network side, the network device 111 may select the target network device based on: determining that the terminal device 120 is in a dual connectivity mode, and the network device 111 and a network device 113 connect to the terminal device 120 and the QoE measurement reporting through both the network device 111 and the network device 113 is paused.

In some embodiment, the network device 111 may select another network device, for example, the network device 112 as the target network device, and transmit the request for establishing the SRB to the network device 112. Accordingly the network device 112 may receive the request for establishing the SRB and transmit to the network device 111 the SRB configuration for establishing the SRB.

In some embodiments, in the scenario where the terminal device 120 is in a dual connectivity mode in which the UE is having connection with both the network device 111 and network device 112, the network device 112 may receive, from the terminal device 120, a request for an AS measurement configuration enabling QoE measurement reporting continuity. And the network device 112 may transmit, to the network device 111, the request for the AS measurement configuration.

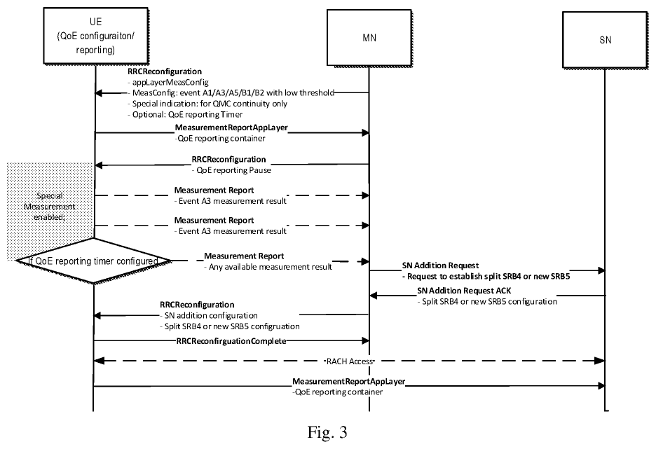

Now the solution herein will be described in detail with reference to FIGS. 3, 4 and 5 below for the purpose of clearer understanding.

FIG. 3 illustrates an example of a process 300 for QoE measurement reporting continuity in accordance with some example embodiments of the present disclosure. For the sake of clarity, UE with QoE configuration and reporting functionality in FIG. 3 can be considered as the terminal device 120 in FIG. 1, MN in FIG. 3 can be considered as the network device 111 in FIG. 1, and SN in FIG. 3 can be considered as the network device 112 in FIG. 1. The process 300 can be performed in the scenario where the terminal device 120 in FIG. 1 is in standalone mode, for example, in the scenario where the terminal device 120 has the connection with only the network device 111 for sending QoE measurements reporting data to network.

In FIG. 3, UE may be in Standalone status and has QoE measurement configured. In the process 300, MN (Serving gNB) can configure special Event or periodic measurement to UE dedicated for QoE reporting continuity. More specifically, as show in FIG. 3. MN transmits the RRCReconfiguration message to UE for AS measurement configuration, with a special indication added in measConfig (or appLayerMeasConfig) to indicate that it is special measurement configuration for QoE reporting continuity.

Further, for the intention of triggering measurement reporting quickly, the measConfig can contain event A1/A3/A5/B1/B2 with low threshold for AS measurement report. In other words, one lower threshold value can be set in QoE reporting dedicated Event Ax/Bx measurement. It should be understood that, instead of lower threshold, higher threshold can be used for AS measurement report, which depends on specific scenario. Alternatively, one shorter period can be set in periodic measurement compared to normal measurement configuration. With respect to the Event measurement configuration, serving gNB also can configure one extra timer in measConfig to UE, which commands UE to report any available measurement result before timer expired, even no measurement result can reach to configured threshold.

Next, as an example, special measurement reporting is enabled only after pause command received. As shown in FIG. 3, when a MeasurementReportAppLayler message with QoE reporting container is received from UE, MN transmits an RRCReconfiguration message with QoE reporting Pause to UE. Then, the special measurement at the side of UE is triggered in response to the obtained Pause command, and UE can transmit a Measurement Report message with AS measurement report (for example, Event A3 measurement result). Further, as mentioned above, even if the Event measurement result cannot be sent without satisfying the configured threshold constraint, a Measurement Report message with any available measurement result will be sent to MN before the configured QoE reporting timer is expired. Alternatively, UE can transmit the Measurement Report message periodically according to periodic measurement configuration.

As another example, for better network controlling, the special measurement reporting can be enabled when QoE reporting data size buffered in the UE AS layer is larger than a NW-configured threshold.

Next, based on the measurement result, serving gNB will send Xn/SN addition request message to selected SN node for DC establishment, new indication added in Xn message to request SN to establish split SRB4 or new SRB5 (used for QoE reporting to SN directly). In particular, MN transmits, to SN, a SN Addition Request message with request to establish split SRB4 or new SRB5.

According to the received SN addition request, SN nodes configures split SRB4 or new SRB5 to UE accordingly. In particular, SN transmits, to MN, a SN Addition Request ACK message with split SRB4 or new SRB5 configuration. Then, MN forwards, to UE, the split SRB4 or new SRB5 configuration via an RRCReconfiguration message, which contains SN addition configuration and the split SRB4 or new SRB5 configuration.

After receiving the related SRB configuration, UE transmits an RRCReconfigurationComplete message to MN. Thus, the RACH access between UE and SN can be achieved, and UE can send QoE measurement report to network via new established SN leg for QoE measurement reporting continuity.

With the process 300, UE's QoE reporting continuity can be implemented by moving from Standalone status to dual connectivity (e.g., NR-DC) status. In this case, the process 300 use the UE connection to SN in DC for QoE measurement reporting and transfer application layer based measurements directly to SN. Such SN addition can be triggered when UE in QoE measurement paused status would keep QoE reporting continuity. This new mechanism asks for RRC and Xn signalling supporting for standardization.

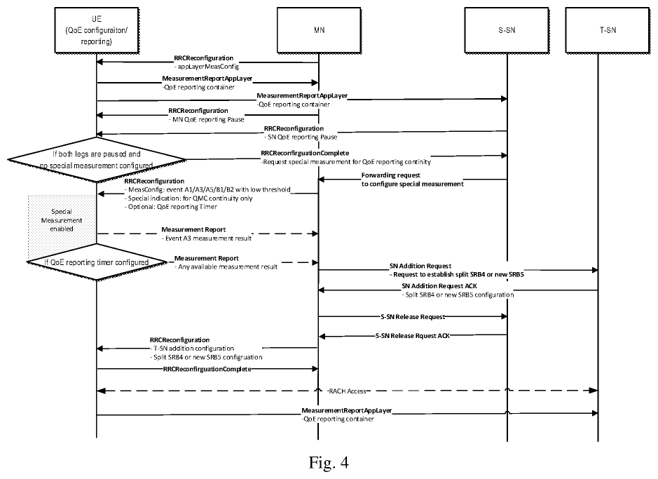

FIG. 4 illustrates an example of a process 400 for QoE measurement reporting continuity in accordance with some example embodiments of the present disclosure. For the sake of clarity, UE with QoE configuration and reporting functionality in FIG. 4 can be considered as the terminal device 120 in FIG. 1, MN in FIG. 4 can be considered as the network device 111 in FIG. 1, T-SN in FIG. 4 can be considered as the network device 112 in FIG. 1, and S-SN in FIG. 4 can be considered as the network device 113 in FIG. 2. The process 400 can be performed in the scenario where the terminal device 120 in FIG. 1 is in dual connectivity mode, for example, in the scenario where the terminal device 120 has the connection with both the network device 111 and the network device 112 for sending QoE measurements reporting data to network. For the sake of brevity, only the difference between the process 400 and the process 300 is described here, and the same or similar details will not be repeated, and may make reference to each other.

As shown in FIG. 4, MN may transmit an RRCReconfiguration message with appLayerMeasConfig to UE for QoE measurement reporting. UE may transmit a MeasurementReportAppLayler message with QoE reporting container to at least one of MN and S-SN. In response to the MeasurementReportAppLayler message, MN may transmit an RRCReconfiguration message with MN QoE reporting Pause to UE, and S-SN may transmit an RRCReconfiguration message with SN QoE reporting Pause to UE. If determining that both legs (MN leg and S-SN leg) are paused and no special measurement is configured, UE may transmit, to S-SN, an RRCReconfigurationComplete message with request special measurement for QoE reporting continuity. Upon receipt of the RRCReconfigurationComplete message, S-SN forwards, to MN, the request to configure special measurement. Afterwards, another connection between UE and other SN (T-SN leg) may be established for QoE reporting continuity, as described in FIG. 3. In addition, MN may transmit an S-SN Release Request message to S-SN, and S-SN may transmit an S-SN Release Request ACK message to MN, so as to optimize the use of network resources.

In process 400, for SN change triggering. UE has been in DC status but both legs can't support QoE reporting. In case of UE received pause command from both MN and SN, to keep QoE reporting continuity, above proposed special measurement mechanism to trigger SN change procedure for QoE reporting continuity can be applied.

With the process 400, UE's QoE reporting continuity can be implemented by SN change. In this case, even both legs are paused in DC. QoE measurement reporting can continue with the new established leg. This new mechanism asks for RRC and Xn signalling supporting for standardization as well.

It is to be understood that when DC capable UE received QoE Pause command from network, if the UE already had measurement configuration for QoE reporting continuity, UE enables the special measurement and reports meaurement result for DC establishment or change; if the UE doesn't have special measurement configuration, new indication can be added in uplink RRC message, e.g., RRCReconfigureComplete message, to request serving gNB to configure special measurement for DC establishment or change.

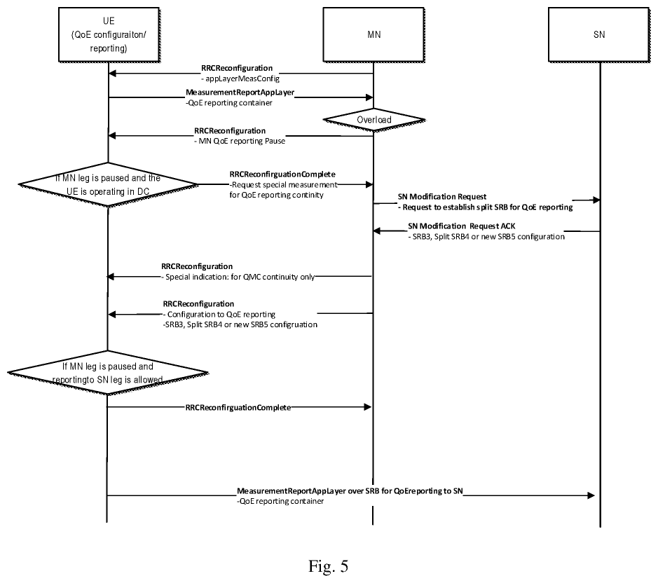

FIG. 5 illustrates an example of a process 500 for QoE measurement reporting continuity in accordance with some example embodiments of the present disclosure. For the sake of clarity, UE with QoE configuration and reporting functionality in FIG. 5 can be considered as the terminal device 120 in FIG. 1, MN in FIG. 5 can be considered as the network device 111 in FIG. 1, and SN in FIG. 5 can be considered as the network device 112 in FIG. 1. The process 500 can be performed in the scenario where the terminal device 120 in FIG. 1 is in dual connectivity mode, for example, in the scenario where the terminal device 120 has the connection with both the network device 111 and the network device 112, but only the connection with the network device 111 has SRB to be used for sending QoE measurements reporting data to network. For the sake of brevity, only the difference between the process 500 and the processes 300, 400 is described here, and the same or similar details will not be repeated, and may make reference to each other.

In process 500, for SN modification, UE is in Dual Connectivity status and having QoE measurement configured but only one connection with MN or SN has SRB to send QoE measurement report. Both MN and SN as serving gNB can configure special Event or periodic measurement to UE dedicated for QoE reporting continuity. New indication added in measConfig to indicate that it is special measurement configuration for QoE reporting continuity (same conditions may apply as for SN addition). The indication may indicate to the UE that is allowed to report QoE measurement results directly to the SN after receiving the pause command from MN who has SRB for QoE measurement report sending, or directly to the MN after receiving the pause command from SN who has SRB for QoE measurement report sending. For example, MN will send Xn/SN modification message to SN for modification with a new indication added in Xn message to request SN to establish split SRB4 (used for QoE reporting to MN through SN leg), or new SRB5 (used for QoE reporting to SN directly). Alternatively, the UE may be enabled to report QoE measurement report to SN through the existing SRB3. For this reason, RRC message (MeasurementReportAppLayer) transfer is enabled over SRB3. For example, SN will send Xn/SN message to MN for modification with a new indication added in Xn message to request MN to establish SRB4 (used for QoE reporting to MN. When received the new indication and Pause command (to temporarily pause QoE reporting), the UE will send QoE report to network via new established SRB (SRB3, split SRB4 or new SRB5 for SN case, SRB4 for MN case) and corresponding leg.

As shown in FIG. 5, when receiving a MeasurementReportAppLayler message with QoE reporting container, MN may transmit an RRCReconfiguration message with MN QoE reporting Pause to UE if it is in overload status. If MN leg is paused and the UE is operating in DC, UE may transmit, to MN, an RRCReconfigurationComplete message with request special measurement for QoE reporting continuity. Then, MN may transmit, to S-SN, a SN Modification Request message with request to establish SRB for QoE reporting. In response to the received SN modification request, SN transmit, to MN, a SN Modification Request ACK message with SRB3, split SRB4 or new SRB5 configuration. Next, MN may transmit, to UE, an RRCReconfiguration message with special indication for QMC continuity only. In addition, MN may transmit, to UE, an RRCReconfiguration message with configuration to QoE reporting and SRB3, split SRB4 or new SRB5 configuration. At the side of terminal device, if MN leg is paused and reporting to SN leg is allowed, UE transmits an RRCReconfigurationComplete message to MN. Thus, the connection between UE and SN can be used for QoE measurement reporting continuity, and a MeasurementReportAppLayler message with QoE reporting container can be transmitted over SRB from UE to SN.

With the process 500, UE's QoE reporting continuity can be implemented by SN modification or SN change. In this case, when UE is in DC status, even if MN leg are paused and SN leg is incapable to be used for QoE measurement reporting, QoE measurement reporting can continue with the new established SRB with one new SN by SN change. This new mechanism asks for RRC and Xn signalling supporting for standardization as well.

In some embodiments, SN has SRB to UE for QoE reporting but MN doesn't have. Option1: SN configures special AS measurement configuration to UE via SRB3 and sends Pause to UE. Option2: SN sends Pause to UE and informs the Pause status to MN that UE QoE reporting has been stopped in SN side. In Option2, SN doesn't configure AS measurement configuration to UE. For Option1: SN may receive AS measurement report from UE via SRB3 and forwards to MN via Xn; MN may establish SRB4 between MN and UE, or based on SN's AS measurement report MN selects one new SN for QoE continuity between new SN and UE (SN change). For Option2: SN informs Pause status to MN via Xn; MN may establish SRB4 between MN and UE, or MN configures special AS measurement reconfiguration to UE and based on MN's AS measurement report MN selects one new SN for QoE continuity between new SN and UE (SN change).

In some embodiments, in Rel-18, for QoE in dual connectivity scenario, there are some options for the pause mechanism of QoE measurement reporting applied in the dual connectivity scenario. Option 1 may be that only MN may send a pause indication related to QoE measurement reporting to the terminal device, and the QoE measurement reporting is paused for both connections between the terminal device and both network nodes (MN and SN), or paused for the connection between the terminal device and MN, or paused for the connection between the terminal device and the SN by one pause indication. With option 1, there may be some interactions between MN and SN. Option 2 may be that MN and SN may send a pause indication related to QoE measurement reporting independently. With option 2, there may be some interactions between MN and SN.

More specifically, in option 1, only MN can pause UE reporting the QoE measurement by a pause indication. Through the Xn interface, MN may inform SN about its overloading status to request to coordinate QoE measurement reporting continuity. Through the Xn interface, SN may inform MN about its overloading status to request MN to pause the QoE measurement reporting through the connection between the SN and the terminal device. Through the Uu interface between the terminal device and the MN, the pause indication related to QoE measurement reporting may need extension, that new indication may be added, to indicate on which leg the QoE measurement reporting is paused-MN only, SN only, or for both.

In option 2, MN and SN may send a pause indication related to QoE measurement reporting independently. Through the Uu interface, SRB3 may be established via RRC Recofiguration procedure to support sending pause indication from SN. Through the Xn interface, in case one node has paused QoE measurement reporting, it may inform another node to avoid pause in another leg for QoE reporting continuity. UE may indicate to the network to request recovery when the pause indication has been received from both MN and SN.

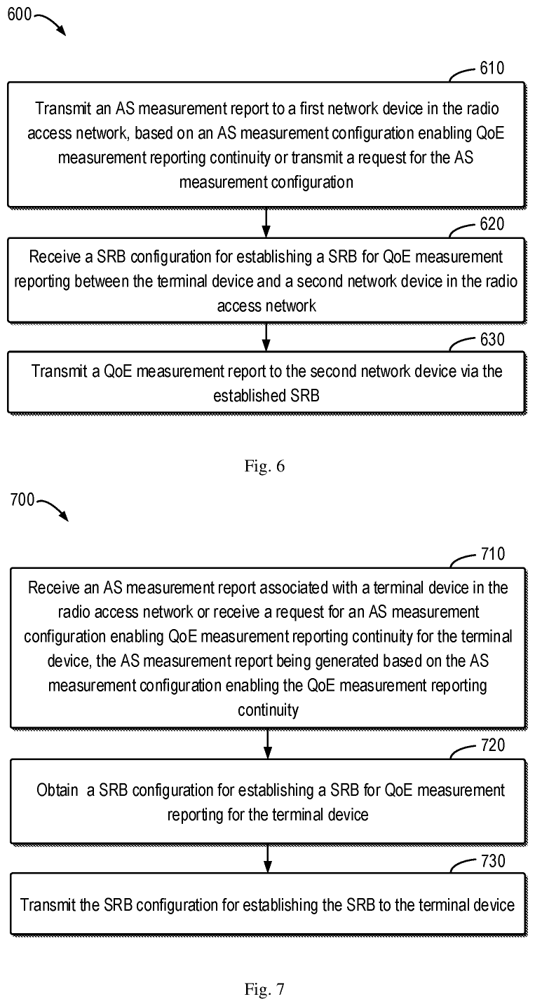

FIG. 6 shows a flowchart of an example method 600 implemented at a terminal device in accordance with some embodiments of the present disclosure. For the purpose of discussion, the method 600 will be described from the perspective of the terminal device 120 with reference to FIG. 1.

At block 610, after receiving a pause indication for QoE measurement reporting, the terminal device 120 transmits an AS measurement report to a first network device in the radio access network, based on an AS measurement configuration enabling QoE measurement reporting continuity or transmit a request for the AS measurement configuration. At block 620, the terminal device 120 receives a SRB configuration for establishing a SRB for QoE measurement reporting between the terminal device and a second network device in the radio access network. At block 630, the terminal device 120 transmits a QoE measurement report to the second network device via the established SRB

In some embodiments, the method 600 further comprises: based on receiving the pause indication for the QoE measurement reporting, performing a measurement based on the AS measurement configuration to generate the AS measurement report.

In some embodiments, the pause indication is received from at least one of the first network device or the second network device.

In some embodiments, the terminal device is in a dual connectivity mode, the first network device is a master node (MN), and the second network device is a secondary node (SN).

In some embodiments, the terminal is in a dual connectivity mode, the first network device is a SN, and the second network device is a MN.

In some embodiments, the method 600 further comprises transmitting the AS measurement report or the request by: based on receiving the pause indication for the QoE measurement reporting, determining whether the terminal device is configured with the AS measurement configuration enabling the QoE measurement reporting continuity; based on determining that the terminal device is configured with the AS measurement configuration, transmitting the AS measurement report; and based on determining that the terminal device is not configured with the measurement configuration, transmitting the request for the AS measurement configuration.

In some embodiments, the method 600 further comprises receiving the pause indication by one of the following: receiving one of a first pause indication from the first network device and a second pause indication from a third network device in the radio access network after the other one of the first pause indication and the second pause indication is received previously, wherein the terminal device is in a dual connectivity mode in which the first network device is a MN and the third network device is a SN of the terminal device; or receiving, from one of the first network device and the third network device, a pause indication that the QoE measurement reporting through both the first network device and the third network device is paused.

In some embodiments, the method 600 further comprises: based on determining that the first pause indication from the first network device is received after the second pause indication from the third network device is received, transmitting, to the first network device, the request for the AS measurement configuration.

In some embodiments, the method 600 further comprises: based on determining that the second pause indication from the third network device is received after the first pause indication is received from the first network device, transmitting, to the third network device, the request for the AS measurement configuration.

In some embodiments, the method 600 further comprises: based on receiving the pause indication that the QoE measurement reporting through both the first network device and the third network device is paused, transmitting, to one of the first network device and the third network device, the request for the AS measurement configuration.

In some embodiments, the terminal device 120 is caused to transmit the AS measurement report or the request based on: determining that an amount of buffered data for the QoE measurement reporting is equal to or greater than a threshold.

In some embodiments, the method 600 further comprises: receiving, from at least one of the first network device or the second network device, the AS measurement configuration enabling the QoE measurement reporting continuity, the AS measurement configuration comprising an indication that the AS measurement configuration is configured for supporting the QoE measurement reporting continuity.

In some embodiments, the AS measurement configuration is received via an RRC reconfiguration message. In some embodiments, the SRB configuration is received via an RRC reconfiguration message. In some embodiments, the request for the AS measurement configuration is transmitted via an uplink RRC message.

In some embodiments, the AS measurement configuration enabling the QoE measurement reporting continuity comprises at least one of the following: a measurement event with a threshold configured for triggering the AS measurement report within a time period for measurement event running determined based on a requirement of the QoE measurement reporting continuity; a periodic measurement within a time period for periodic measurement running determined based on the requirement of the QoE measurement reporting continuity; or a timer for causing the terminal device to report an available measurement result based on expiry of the timer, even if no measurement result reaches the configured threshold.

In some embodiments, the terminal device 120 receives the SRB configuration by: receiving the SRB configuration from the first network device or the second network device.

In some embodiments, the SRB comprises at least one of an existing SRB3, a split SRB4, or a new SRB5.

FIG. 7 shows a flowchart of an example method 700 implemented at a network device in accordance with some embodiments of the present disclosure. For the purpose of discussion, the method 700 will be described from the perspective of the network device 111 with reference to FIG. 1 or a first network device.

At block 710, the network device 111 receives an AS measurement report associated with a terminal device in the radio access network or receive a request for an AS measurement configuration enabling QoE measurement reporting continuity for the terminal device, the AS measurement report being generated based on the AS measurement configuration enabling the QoE measurement reporting continuity. At block 720, the network device 111 obtains a SRB configuration for establishing a SRB for QoE measurement reporting for the terminal device. At block 730, the network device 111 transmits the SRB configuration for establishing the SRB to the terminal device.

In some embodiments, the SRB for the QoE measurement reporting is between the terminal device and a second network device in the radio access network.

In some embodiments, the SRB for the QoE measurement reporting is between the terminal device and the first network device.

In some embodiments, the network device 111 obtains the SRB configuration by: based on receiving the AS measurement report or the request from the terminal device, transmitting, to the second network device, a request for establishing the SRB between the terminal device and the second network device; and receiving, from the second network device, the SRB configuration for establishing the SRB.

In some embodiments, the network device 111 obtains the SRB configuration by: based on receiving the AS measurement report or the request for establishing the SRB from the second network device, determining the SRB configuration for establishing the SRB between the first network device and the terminal device.

In some embodiments, the network device 111 transmits the request for establishing the SRB by: transmitting, to the second network device, an SN addition message or an SN modification message comprising an indication for requesting the second network device to establish the SRB.

In some embodiments, the method 700 further comprises: selecting, based on the received AS measurement report, a target network device from a plurality of candidate network devices as the second network device.

In some embodiments, the network device 111 selects the target network device based on: determining that the terminal device is in a standalone mode; or determining that the terminal device is in a dual connectivity mode, wherein the first network device and a third network device connect to the terminal device and the QoE measurement reporting through both the first network device and the third network device is paused.

In some embodiments, the method 700 further comprises: prior to receiving the AS measurement report, transmitting, to the terminal device, a pause indication for the QoE measurement reporting.

In some embodiments, the method 700 further comprises: configuring a threshold for causing the terminal device to transmit the AS measurement report based on determining that an amount of buffered data of the QoE measurement reporting at the terminal device is equal to or greater than the threshold.

In some embodiments, the method 700 further comprises: transmitting, to the terminal device, the AS measurement configuration enabling the QoE measurement reporting continuity, the AS measurement configuration comprising an indication that the AS measurement configuration is configured for supporting the QoE measurement reporting continuity.

In some embodiments, the AS measurement configuration is transmitted via an RRC reconfiguration message to the terminal device. In some embodiments, the SRB configuration is transmitted via an RRC reconfiguration message. In some embodiments, the request for the AS measurement configuration is received via an uplink RRC message.

In some embodiments, the AS measurement configuration enabling the QoE measurement reporting continuity comprises at least one of the following: a measurement event with a threshold configured for triggering the measurement event enabling and the measurement report within a time period determined based on a requirement of the QoE measurement reporting continuity; a periodic measurement configured for triggering the periodic measurement enabling within a time period determined based on the requirement of the QoE measurement reporting continuity; or a timer for causing the terminal device to report an available measurement result based on expiry of the timer, even if no measurement result reaches the configured threshold.

In some embodiments, the method 700 further comprises: transmitting, to the second network device, information about overloading status of the first network device to request the second network device to coordinate the QoE measurement reporting continuity, wherein the terminal device is in a dual connectivity mode in which the first network device is a MN and the second network device is a SN of the terminal device.

In some embodiments, the method 700 further comprises: transmitting, to the second network device, an indication that the QoE measurement reporting through the first network device is paused.

In some embodiments, the SRB comprises at least one of an existing SRB3, a split SRB4, or a new SRB5.

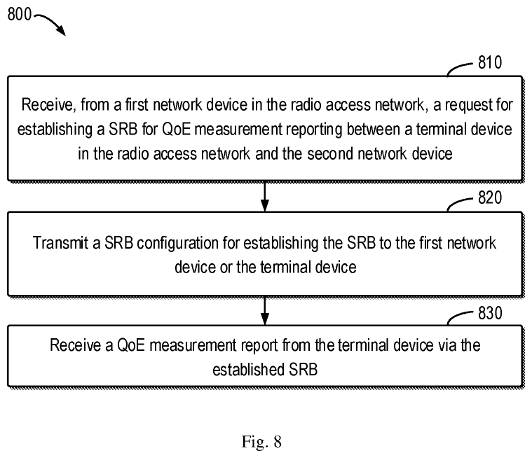

FIG. 8 shows a flowchart of an example method 800 implemented at a network device in accordance with some embodiments of the present disclosure. For the purpose of discussion, the method 800 will be described from the perspective of the network device 112 with reference to FIG. 1 or a second network device.

At block 810, the network device 112 receives, from a first network device in the radio access network, a request for establishing a SRB for QoE measurement reporting between a terminal device in the radio access network and the second network device. At block 820, the network device 112 transmits a SRB configuration for establishing the SRB to the first network device or the terminal device. At block 830, the network device 112 receives a QoE measurement report from the terminal device via the established SRB.

In some embodiments, the method 800 further comprises: receiving, from the terminal device, a request for an AS measurement configuration enabling QoE measurement reporting continuity; and transmitting, to the first network device, the request for the AS measurement configuration.

In some embodiments, the method 800 further comprises: receiving, from the terminal device, an AS measurement report based on an AS measurement configuration enabling QoE measurement reporting continuity or receiving a request for the AS measurement configuration enabling QoE measurement reporting continuity; and transmitting, to the first network device, the AS measurement report or a request for establishing the SRB between the terminal device and the first network device.

In some embodiments, the network device 112 receives the request for establishing the SRB by: receiving, from the first network device, an SN addition message or an SN modification message comprising an indication for requesting the second network device to establish the SRB.

In some embodiments, the method 800 further comprises: transmitting, to the first network device, information about overloading status of the second network device to request the first network device to pause the QoE measurement reporting through the second network device, wherein the terminal device is in a dual connectivity mode in which the first network device is a MN and the second network device is a SN of the terminal device.

In some embodiments, the method 800 further comprises: transmitting, to the first network device, an indication that the QoE measurement reporting through the second network device is paused.

In some embodiments, the SRB comprises at least one of an existing SRB3, a split SRB4, or a new SRB5.

In some embodiments, an apparatus capable of performing any of the method 600 (for example, the terminal device 120) may comprise means for performing the respective steps of the method 600. The means may be implemented in any suitable form. For example, the means may be implemented in a circuitry or software module.

In some embodiments, the apparatus comprises: means for after receiving a pause indication for QoE measurement reporting, transmitting, at a terminal device in a radio access network, an AS measurement report to a first network device in the radio access network, based on an AS measurement configuration enabling QoE measurement reporting continuity or transmitting a request for the AS measurement configuration; means for receiving a SRB configuration for establishing a SRB for QoE measurement reporting between the terminal device and a second network device in the radio access network; and means for transmitting a QoE measurement report to the second network device via the established SRB.

In some embodiments, the apparatus further comprises: means for based on receiving the pause indication for the QoE measurement reporting, performing a measurement based on the AS measurement configuration to generate the AS measurement report.

In some embodiments, the pause indication is received from at least one of the first network device or the second network device.

In some embodiments, the terminal device is in a dual connectivity mode, the first network device is a master node (MN), and the second network device is a secondary node (SN).

In some embodiments, the terminal device is in a dual connectivity mode, the first network device is a SN, and the second network device is a MN.

In some embodiments, means for transmitting the AS measurement report or the request comprise means for transmitting the AS measurement report or the request by: based on receiving the pause indication for the QoE measurement reporting, determining whether the terminal device is configured with the AS measurement configuration enabling the QoE measurement reporting continuity; based on determining that the terminal device is configured with the AS measurement configuration, transmitting the AS measurement report; and based on determining that the terminal device is not configured with the measurement configuration, transmitting the request for the AS measurement configuration.

In some embodiments, means for receiving the pause indication comprise means for receiving the pause indication by one of the following: receiving one of a first pause indication from the first network device and a second pause indication from a third network device in the radio access network after the other one of the first pause indication and the second pause indication is received previously, wherein the terminal device is in a dual connectivity mode in which the first network device is a MN and the third network device is a SN of the terminal device; or receiving, from one of the first network device and the third network device, a pause indication that the QoE measurement reporting through both the first network device and the third network device is paused.

In some embodiments, the apparatus further comprises means for based on determining that the first pause indication from the first network device is received after the second pause indication from the third network device is received, transmitting, to the first network device, the request for the AS measurement configuration.

In some embodiments, the apparatus further comprises means for based on determining that the second pause indication from the third network device is received after the first pause indication is received from the first network device, transmitting, to the third network device, the request for the AS measurement configuration.

In some embodiments, the apparatus further comprises means for based on receiving the pause indication that the QoE measurement reporting through both the first network device and the third network device is paused, transmitting, to one of the first network device and the third network device, the request for the AS measurement configuration.

In some embodiments, means for transmitting the AS measurement report or the request comprises means for transmitting the AS measurement report or the request based on: determining that an amount of buffered data for the QoE measurement reporting is equal to or greater than a threshold.

In some embodiments, the apparatus further comprises means for receive, from at least one of the first network device or the second network device, the AS measurement configuration enabling the QoE measurement reporting continuity, the AS measurement configuration comprising an indication that the AS measurement configuration is configured for supporting the QoE measurement reporting continuity.

In some embodiments, the AS measurement configuration is received via an RRC reconfiguration message. In some embodiments, the SRB configuration is received via an RRC reconfiguration message. In some embodiments, the request for the AS measurement configuration is transmitted via an uplink RRC message.

In some embodiments, the AS measurement configuration enabling the QoE measurement reporting continuity comprises at least one of the following: a measurement event with a threshold configured for triggering the AS measurement report within a time period for measurement event running determined based on a requirement of the QoE measurement reporting continuity, a periodic measurement within a time period for periodic measurement running determined based on the requirement of the QoE measurement reporting continuity, or a timer for causing the terminal device to report an available measurement result based on expiry of the timer, even if no measurement result reaches the configured threshold.

In some embodiments, the apparatus further comprises means for receiving the SRB configuration by: receiving the SRB configuration from the first network device or the second network device.

In some embodiments, the SRB comprises at least one of an existing SRB3, a split SRB4, or a new SRB5.

In some embodiments, the apparatus further comprises means for performing other steps in some embodiments of the method 600. In some embodiments, the means comprises at least one processor; and at least one memory including computer program code, the at least one memory and computer program code configured to, with the at least one processor, cause the performance of the apparatus.

In some embodiments, an apparatus capable of performing any of the method 700 (for example, the network device 111) may comprise means for performing the respective steps of the method 700. The means may be implemented in any suitable form. For example, the means may be implemented in a circuitry or software module.

In some embodiments, the apparatus comprises: means for receiving, at a first network device in a radio access network, an AS measurement report associated with a terminal device in the radio access network or receiving a request for an AS measurement configuration enabling quality of experience (QoE) measurement reporting continuity for the terminal device, the AS measurement report being generated based on the AS measurement configuration enabling the QoE measurement reporting continuity; means for obtaining a SRB configuration for establishing a SRB for QoE measurement reporting for the terminal device; and means for transmitting the SRB configuration for establishing the SRB to the terminal device.

In some embodiments, the SRB for the QoE measurement reporting is between the terminal device and a second network device in the radio access network.

In some embodiments, the SRB for the QoE measurement reporting is between the terminal device and the first network device.

In some embodiments, means for obtaining the SRB configuration comprise means for obtaining the SRB configuration by: based on receiving the AS measurement report or the request from the terminal device, transmitting, to the second network device, a request for establishing the SRB between the terminal device and the second network device; and receiving, from the second network device, the SRB configuration for establishing the SRB.

In some embodiments, means for obtaining the SRB configuration comprise means for obtaining the SRB configuration by: based on receiving the AS measurement report or the request for establishing the SRB from the second network device, determining the SRB configuration for establishing the SRB between the first network device and the terminal device.

In some embodiments, means for transmitting the request for establishing the SRB comprise means for transmitting the request for establishing the SRB by: transmitting, to the second network device, an SN addition message or an SN modification message comprising an indication for requesting the second network device to establish the SRB.

In some embodiments, the apparatus further comprises means for selecting, based on the received AS measurement report, a target network device from a plurality of candidate network devices as the second network device.

In some embodiments, means for selecting the target network device comprise means for selecting the target network device based on: determining that the terminal device is in a standalone mode; or determining that the terminal device is in a dual connectivity mode, wherein the first network device and a third network device connect to the terminal device and the QoE measurement reporting through both the first network device and the third network device is paused.

In some embodiments, the apparatus further comprises means for prior to receiving the AS measurement report, transmitting, to the terminal device, a pause indication for the QoE measurement reporting.

In some embodiments, the apparatus further comprises means for configuring a threshold for causing the terminal device to transmit the AS measurement report based on determining that an amount of buffered data of the QoE measurement reporting at the terminal device is equal to or greater than the threshold.

In some embodiments, the apparatus further comprises means for transmitting, to the terminal device, the AS measurement configuration enabling the QoE measurement reporting continuity, the AS measurement configuration comprising an indication that the AS measurement configuration is configured for supporting the QoE measurement reporting continuity.

In some embodiments, the AS measurement configuration is transmitted via an RRC reconfiguration message to the terminal device. In some embodiments, the SRB configuration is transmitted via an RRC reconfiguration message. In some embodiments, the request for the AS measurement configuration is received via an uplink RRC message.

In some embodiments, the AS measurement configuration enabling the QoE measurement reporting continuity comprises at least one of the following: a measurement event with a threshold configured for triggering the measurement event enabling and the measurement report within a time period determined based on a requirement of the QoE measurement reporting continuity, a periodic measurement configured for triggering the periodic measurement enabling within a time period determined based on the requirement of the QoE measurement reporting continuity, or a timer for causing the terminal device to report an available measurement result based on expiry of the timer, even if no measurement result reaches the configured threshold.

In some embodiments, the apparatus further comprises means for transmitting, to the second network device, information about overloading status of the first network device to request the second network device to coordinate the QoE measurement reporting continuity, wherein the terminal device is in a dual connectivity mode in which the first network device is a MN and the second network device is a SN of the terminal device.

In some embodiments, the apparatus further comprises means for transmitting, to the second network device, an indication that the QoE measurement reporting through the first network device is paused.

In some embodiments, the SRB comprises at least one of an existing SRB3, a split SRB4, or a new SRB5.

In some embodiments, the apparatus further comprises means for performing other steps in some embodiments of the method 700. In some embodiments, the means comprises at least one processor; and at least one memory including computer program code, the at least one memory and computer program code configured to, with the at least one processor, cause the performance of the apparatus.

In some embodiments, an apparatus capable of performing any of the method 800 (for example, the network device 112) may comprise means for performing the respective steps of the method 800. The means may be implemented in any suitable form. For example, the means may be implemented in a circuitry or software module.

In some embodiments, the apparatus comprises: means for receiving, at a second network device in a radio access network, from a first network device in the radio access network, a request for establishing a SRB for QoE measurement reporting between a terminal device in the radio access network and the second network device; means for transmitting a SRB configuration for establishing the SRB to the first network device or the terminal device; and means for receiving a QoE measurement report from the terminal device via the established SRB.

In some embodiments, the apparatus further comprises means for receiving, from the terminal device, a request for an AS measurement configuration enabling QoE measurement reporting continuity; and means for transmitting, to the first network device, the request for the AS measurement configuration.

In some embodiments, the apparatus further comprises means for receiving, from the terminal device, an AS measurement report based on an AS measurement configuration enabling QoE measurement reporting continuity or receiving a request for the AS measurement configuration enabling QoE measurement reporting continuity; and means for transmitting, to the first network device, the AS measurement report or a request for establishing the SRB between the terminal device and the first network device.

In some embodiments, means for receiving the request for establishing the SRB comprise means for receiving the request for establishing the SRB by: receiving, from the first network device, an SN addition message or an SN modification message comprising an indication for requesting the second network device to establish the SRB.

In some embodiments, the apparatus further comprises means for transmitting, to the first network device, information about overloading status of the second network device to request the first network device to pause the QoE measurement reporting through the second network device, wherein the terminal device is in a dual connectivity mode in which the first network device is a MN and the second network device is a SN of the terminal device.

In some embodiments, the apparatus further comprises means for transmitting, to the first network device, an indication that the QoE measurement reporting through the second network device is paused.

In some embodiments, the SRB comprises at least one of an existing SRB3, a split SRB4, or a new SRB5.

In some embodiments, the apparatus further comprises means for performing other steps in some embodiments of the method 800. In some embodiments, the means comprises at least one processor; and at least one memory including computer program code, the at least one memory and computer program code configured to, with the at least one processor, cause the performance of the apparatus.

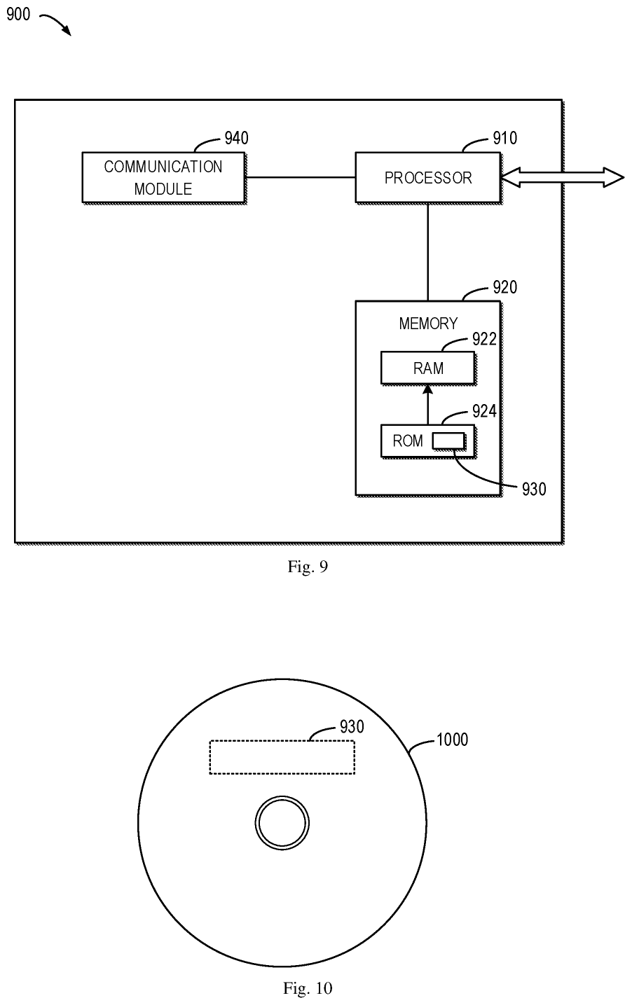

FIG. 9 is a simplified block diagram of a device 900 that is suitable for implementing embodiments of the present disclosure. The device 900 may be provided to implement the communication device, for example the terminal device 120, the network device 111 or the network device 112 as shown in FIG. 1. As shown, the device 900 includes one or more processors 910, one or more memories 940 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 1020. The processor 910 may perform any suitable actions and processing by loading the program 930 into the RAM 1020.

The embodiments of the present disclosure may be implemented by means of the program 930 so that the device 900 may perform any process of the disclosure as discussed with reference to FIGS. 2 to 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600, 700 or 800 as described above with reference to FIG. 6, 7 or 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory.” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first terminal device comprising:
at least one processor; and
at least one memory storing instructions that, when executed by the at least one processor, cause the first terminal device to:
receive a plurality of sidelink (SL) positioning reference signal (PRS) configurations from a plurality of terminal devices;
determine, based on the plurality of SL PRS configurations, whether the plurality of terminal devices select overlapping resources for a plurality of SL PRS transmissions; and
based on determining that the plurality of terminal devices select overlapping resources for the plurality of SL PRS transmissions, transmit, to a second terminal device among the plurality of terminal devices, a request to update an SL PRS transmission by the second terminal device.

2. The first terminal device of claim 1, wherein the request comprises:
a request for muting a SL PRS.

3. The first terminal device of claim 2, wherein the request further indicates that the SL PRS is muted in a first slot, and wherein the first terminal device is further caused to transmit, to a third terminal device of the plurality of terminal devices, the request for muting the SL PRS in a second slot, and the second slot and the first slot being staggered in the time domain.

4. (canceled)

5. The first terminal device of claim 2, wherein the first terminal device is caused to transmit the request for muting the SL PRS by:
receiving a first SL PRS from the second terminal device and a second SL PRS from a third terminal device among the plurality of terminal devices on the overlapping resources;
determining that a first received power of the first SL PRS is greater than a second received power of the second SL PRS by a power threshold; and
transmitting the request for muting the first SL PRS to the second terminal device.

6. The first terminal device of claim 2, wherein the first terminal device is caused to transmit the request for muting the SL PRS by:
receiving, from a network device, a muting criterion for determining the SL PRS to be muted; and
transmit, based on the muting criterion, the request to the second terminal device.

7. The first terminal device of claim 2, wherein the request comprises:
a request for muting a beam associated with the SL PRS transmission.

8. The first terminal device of claim 2, wherein the first terminal device is caused to transmit the request for muting the SL PRS by at least one of:
transmitting the request via a sidelink control information (SCI) signaling:
transmitting the request via a sidelink LTE positioning protocol (SLPP) message: or
transmitting the request via a group cast signaling to mute the SL PRS transmitted from a group of terminal devices among the plurality of terminal devices.

9. The first terminal device of claim 2, wherein the first terminal device is further caused to:
receive, from the second terminal device, an indication that the SL PRS is not to be muted; and
transmit the request to a third terminal device other than the second terminal device among the plurality of terminal devices.

10. The first terminal device of claim 1, wherein the request comprises at least one of:
a request for changing an SL PRS identification (ID) or
a request for using an orthogonal cover code (OCC); and wherein the request further indicates at least one of an SL PRS ID or an SL PRS sequence initialization.

11. (canceled)

12. The first terminal device of claim 10, wherein the first terminal device is caused to transmit the request for changing the SL PRS ID by:
determining a first distance between the terminal device and the second terminal device;
determining a second distance between the terminal device and a third terminal device of the plurality of terminal devices; and
transmitting, based on a distance difference between the first distance and the second distance satisfying a distance threshold, the request for changing the SL PRS ID or the request for using the OCC to the second terminal device.

13. The first terminal device of claim 1, wherein the first terminal device is further caused to:
receive, from the second terminal device, an indication of a muting pattern.

14. The terminal device of claim 13, wherein the first terminal device is caused to transmit the request by:
transmitting, to the second terminal device, an activation message for activating the muting pattern.

15. A second terminal device comprising:
at least one processor; and
at least one memory storing instructions that, when executed by the at least one processor, cause the terminal device to:
transmit a sidelink (SL) positioning reference signal (PRS) configuration to a first terminal device;
receive a request to update an SL PRS transmission; and
update, in accordance with a determination that the SL PRS is to be update, the SL PRS transmission based on the request.

16. The second terminal device of claim 15, wherein the request comprises at least one of:
a request for muting a SL PRS, or
a request for muting a beam associated with the SL PRS.

17. (canceled)

18. The second terminal device of claim 16 or 17, wherein the second terminal device is caused to update the SL PRS transmission by at least one of:
muting transmitting the SL PRS based on the request: or
disabling the beam associated with the SL PRS.

19. The second terminal device of claim 16, wherein the second terminal device avoids transmitting the SL PRS, and wherein the second terminal device is further caused to:
transmit, to another terminal device to be positioned, an indication that the SL PRS is muted.

20. The second terminal device of claim 16, wherein the second terminal device is further caused to:
transmit, in accordance with a determination that the SL PRS is not to be updated, an indication that the SL PRS is not to be muted.

21. The second terminal device of claim 15, wherein the request comprises at least one of:
a request for changing a SL PRS Identification (ID) or
a request for using an orthogonal cover code (OCC); and wherein the request further indicates at least one of an SL PRS ID or an SL PRS sequence initialization.

22-26. (canceled)

27. A method comprising:
receiving, at a first terminal device, a plurality of sidelink (SL) positioning reference signal (PRS) configurations from a plurality of terminal devices;
determining, based on the plurality of SL PRS configurations, whether the plurality of terminal devices select overlapping resources for a plurality of sidelink (SL) positioning reference signal (PRS) transmissions; and
based on determining that the plurality of terminal devices select overlapping resources for the plurality of SL PRS transmissions, transmitting, to a second terminal device among the plurality of terminal devices, a request to update an SL PRS transmission by the second terminal device.

28. A method comprising:
transmitting a sidelink (SL) positioning reference signal (PRS) configuration to a first terminal device;
receiving a request to update an SL PRS transmission; and
updating, in accordance with a determination that the SL PRS is to be updated, the SL PRS transmission based on the request.

29-33. (canceled)
